(19) United States
(12) Patent Application Publication
(10) Pub. No.: US 2026/0064102 A1
(43) Pub. Date: Mar. 5, 2026

(54) SYSTEM AND METHOD FOR OPTIMIZING FABRICATION PROCESSES IN COMPUTER-ASSISTED MACHINE TOOLS

(71) Applicants: John M. Tursky, Hillsborough, NJ (US); Andrii Velhov, Somerset, NJ (US); Neil Chheda, Avenel, NJ (US)

(72) Inventors: John M. Tursky, Hillsborough, NJ (US); Andrii Velhov, Somerset, NJ (US); Neil Chheda, Avenel, NJ (US)

(21) Appl. No.: 18/825,696

(22) Filed: Sep. 5, 2024

(51) Int. Cl. G05B 19/4155

(52) U.S. Cl. CPC G05B 19/4155; G05B 2219/40261

(57) ABSTRACT

A system and method optimizes fabrication processes in computer-assisted machine tools. CNC machine (102) with a CNC motor/slide (102b) manipulates a workpiece (102a) based on programmed instructions. Force sensor (102c) on the CNC motor/slide measures real-time exerted forces. Force data is compiled into a time-series dataset by data collection module (106a), representing the force profile for each produced part. Machine learning analysis module (106b) examines the force data to identify patterns linking force profiles with part quality, generating predictive profiles for high-quality production. Adaptive control module (106c) adjusts the CNC motor/slide parameters in real-time or for future parts based on these profiles. Operating on feedback loop module (106d), the system continuously collects and analyzes force data, enabling ongoing improvements and dynamic adjustments to CNC operations for optimal fabrication outcomes.

### BACKGROUND OF THE INVENTION

### 1. Field of the Invention

The present invention relates to the field of manufacturing technology and, more particularly, to computer-assisted control of machine tools, such as Computer Numerical Control (CNC) machinery, and the optimization of fabrication processes.

### 2. Description of the Prior Art

CNC machines play a pivotal role in the manufacturing industry by facilitating the precise fabrication of components from raw materials. These machines operate by executing pre-programmed sequences of controlled movements, utilizing tools such as drills, lathes, and mills to shape the material according to the provided specifications. The CNC systems rely on a predefined set of parameters, including feed rate, spindle speed, and tool path, which are programmed into the machine to ensure accurate and consistent part production. Conventionally, skilled operators manually adjust these parameters based on their experience and expertise. However, this traditional setup often entails a trial-and-error approach to fine-tune the machining process, with adjustments being made based on post-production quality assessments.

Typically, in the manufacturing industry, controlling machine tools for processes such as machining metal or sheet metal involves a sequential process. Conventionally, a computer-aided design (CAD) system is employed to create a digital model of the component to be produced. The model is then utilized in computer-aided manufacturing (CAM) to generate a computerized numerical control (CNC) data set, commonly known as CNC code or a CNC program. This CNC program is then electronically transmitted to the control unit of a machine tool, which could be a laser cutting machine, a bending machine, or an additive manufacturing machine. Upon receiving the CNC program, the machine tool executes the required machining operations by following predefined control routines that manage various components of the machine tool.

The problem associated with the known technologies is that they heavily rely on manual intervention and adjustments to achieve optimal machining conditions. Although CAM systems can convert CAD models into control data sets and generate machine-readable instructions, the process is not fully automated and often requires the expertise of skilled operators. These operators need to manually adjust machining parameters, which can be time-consuming and error-prone. This manual adjustment process is necessary because the predefined technology tables used by CAM systems do not account for real-time variations in the machining process, such as tool wear, material inconsistencies, or machine calibration errors.

Patent publication no. US20230004150 A1 discloses a method that creates numerical control data sets for controlling machine tools. The control data sets are read from the machine tools. A first component data set representing a first component design model is received. A first numerical control data set is created for the first component data set using control program generation software, having an assessment routine using a trained machine learning algorithm with settable parameters, and it relies on static parameters and uncontrolled inputs based on previously bent cannulas, which restricts the system's ability to adapt to real-time variations during the fabrication process. This static approach can result in inconsistencies in product quality, as it does not account for dynamic changes that may occur during machining. Secondly, the system lacks real-time feedback integration, meaning it does not utilize real-time sensor data to make immediate adjustments during the bending process.

Further, patent publication US 20230205180 A1 discloses a system and a computer-implemented method for controlling a part-processing device of a computer numerical control machine to bend cannulas. The method comprises the step of receiving one or more set parameters relating to one or more desired bend characteristics. The method also comprises the step of determining one or more uncontrolled inputs, the one or more uncontrolled inputs comprising bend parameters of a previously bent cannula. It relies on historical bend parameters and predefined set parameters, limiting its ability to adapt to real-time variations during the bending process, which can result in suboptimal adjustments if current conditions differ from historical data. Additionally, the system lacks real-time force sensor data, important for making immediate adjustments and corrections, leading to potential inefficiencies and lower quality control. The method is specifically tailored for bending cannulas, restricting its application to other CNC machining tasks and materials, thus reducing its versatility. Furthermore, its reactive approach, based on past data rather than continuous real-time inputs, prevents prompt correction of issues during fabrication, increasing waste and defect rates.

Efforts have been made in the past to provide a solution to some of the stated problems above, yet traditional manufacturing methods often rely on static programming and manual adjustments, leading to suboptimal results and increased waste.

Thus, there exists a need in the art to develop an intelligent system that can dynamically adapt machining parameters in real-time, based on data-driven insights, to ensure consistent quality and reduce production costs.

### OBJECTIVE OF THE INVENTION

An objective of the present invention is to provide an intelligent control system and/or method for machine tools that dynamically adjusts machining parameters in real-time. In particular, the objective is to overcome the limitations of static programming and manual adjustments, ensuring optimal machining conditions and consistent product quality.

Another objective of the present invention is to integrate real-time feedback mechanisms using sensor data in computer-assisted control systems, thus allowing continuous monitoring of machining conditions and making immediate adjustments based on real-time inputs, thereby reducing the reliance on predefined parameters and historical data.

One more objective of the present invention is to enhance a control system's adaptability to real-time variations in the machining process, such as tool wear, material inconsistencies, and machine calibration errors, thus maintaining high precision and reducing the occurrence of defects and waste.

Further, by automating the adjustment of machining parameters through advanced machine learning algorithms and data-driven insights, the invention seeks to minimize the need for skilled manual intervention.

Furthermore, the intelligent control system and/or method, according to the present invention, is designed to improve the overall efficiency of the machining process. By ensuring optimal conditions and reducing manual adjustments, the system aims to lower production costs and increase throughput.

Another aim of the present invention is to propose a control system that is versatile and applicable to a wide range of CNC machining tasks and materials.

Ultimately, the invention seeks to provide a comprehensive solution to the challenges faced in modern manufacturing by addressing the need for dynamic adaptability, real-time feedback integration, and reducing reliance on manual interventions, thereby paving the way for more advanced and efficient manufacturing processes.

### SUMMARY OF THE INVENTION

The present invention provides a comprehensive system for optimizing fabrication processes in a computer-assisted machine tool. The system integrates real-time force sensing with machine learning analysis and adaptive control mechanisms to dynamically adjust CNC machine parameters, ensuring optimal fabrication outcomes.

According to an embodiment of the present invention, the system utilizes advanced machine learning algorithms to analyze force data collected during fabrication processes, identifying patterns that correlate with part quality and enabling material-specific optimization.

According to another embodiment of the present invention, the adaptive control module makes real-time adjustments to CNC machine parameters based on predictive force profiles generated by the machine learning analysis, enhancing fabrication precision and efficiency.

According to another embodiment, the system operates within a closed-loop feedback mechanism, continuously collecting and analyzing force data to make incremental improvements and dynamic adjustments to CNC machine operations, thereby achieving optimal fabrication outcomes.

According to an embodiment of the present invention, the system integrates a force sensor capable of measuring forces in terms of torque or pressure in pounds per square inch (PSI).

According to another embodiment of the present invention, the machine learning model employed is selected from a group consisting of regression models, time-series forecasting models, and neural networks, trained to recognize patterns in the force data correlating with successful fabrication outcomes.

The technical effect achieved by the present invention is a significant advancement in the field of advanced manufacturing technologies. By seamlessly integrating real-time force sensing with machine learning analysis and adaptive control mechanisms, the invention enables precise and efficient optimization of fabrication processes, leading to improved quality, reduced waste, and increased efficiency.

It will be understood that this disclosure is not limited to the particular systems, and methodologies described, as there can be multiple possible embodiments of the present disclosure which are not expressly illustrated in the present specification. It is also to be understood that the terminology used in the description is to describe the particular versions or embodiments only, and is not intended to limit the scope of the present invention.

### BRIEF DESCRIPTION OF THE DRAWINGS

Various objects, features, aspects, and advantages of the inventive subject matter will become more apparent from the following detailed description of preferred embodiments, along with the accompanying drawing figures in which numerals represent like components.

FIG. 1 illustrates a system for optimizing fabrication processes in a computer-assisted machine tool in accordance with an embodiment of the present disclosure;

FIG. 2 illustrates a flowchart explaining the working operation of a fabrication process using the system of FIG. 1, in accordance with an embodiment of the present disclosure; and

FIG. 3 illustrates a method for optimizing fabrication processes in a computer-assisted machine tool in accordance with an embodiment of the present disclosure.

### DETAILED DESCRIPTION OF THE INVENTION

Some embodiments of this invention, illustrating all its features, will now be discussed in detail. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present invention, the preferred systems and methods are herein described.

The present invention aims to optimize fabrication processes in a computer-assisted machine tool by seamlessly integrating real-time force sensors with machine learning analysis. The present invention represents a comprehensive (Machine Learning) ML-assisted framework specifically designed to optimize fabrication processes utilizing (Computer Numerical Control) CNC machines. This integration allows for dynamic adjustment of CNC machinery during the fabrication process, intending to continuously adapt machine movements based on direct force measurements.

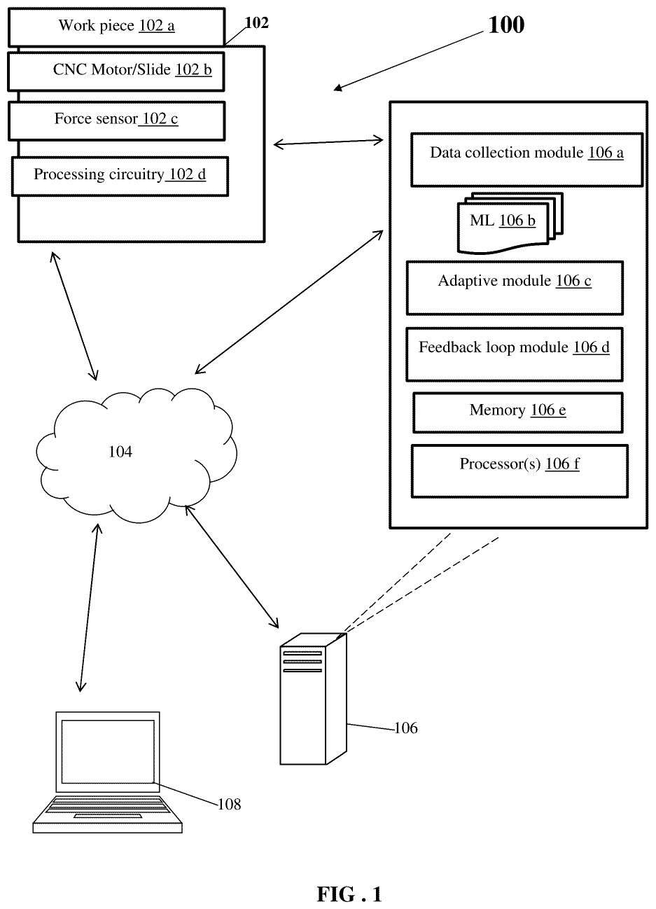

FIG. 1 illustrates a system 100 designed for optimizing fabrication processes, specifically using a CNC (Computer Numerical Control) machine 102, in accordance with an embodiment of the invention. The CNC machine 102 performs various fabrication tasks such as cutting, bending, and forming materials based on the programmed instructions. The CNC machine 102 typically operates based on pre-programmed instructions that dictate the exact movements and actions required to shape a workpiece 102a, which could be the material or part undergoing fabrication within the CNC machine 102.

In an embodiment, a CNC Motor/Slide 102b serves as the hardware component responsible for physically maneuvering the workpiece 102a within the CNC machine 102. Its primary function is to execute both linear and rotary movements according to the programmed instructions provided to the CNC machine 102. For instance, the CNC Motor/Slide 102b drives the cutting tool along a linear path or rotates the workpiece 102a about its axis to perform milling or drilling operations.

Further, a force sensor 102c monitors and measures the forces involved during the fabrication process. The force sensor 102c is positioned where the machine comes into contact with workpiece 102a and captures, in real-time, various parameters indicative of force application. These parameters may include pressure, stress, strain, or torque, depending on the specific requirements of the fabrication process and the type of material being processed. By continuously monitoring these force-related metrics, the force sensor 102c provides data about the dynamics of the fabrication process. This real-time data allows the system to precisely track the force profile throughout the fabrication process, enabling timely adjustments and optimizations to ensure optimal fabrication outcomes.

In an embodiment, a processing circuitry 102d is adapted to receive data from the force sensor and is responsible for managing and analyzing the same. The processor 102d interprets the real-time force measurements and coordinates with the CNC machine 102 to make necessary adjustments in its operations.

For example, the processing circuitry can include any suitable processors, controllers, digital signal processors, microcontrollers, and/or other suitably programmed or programmable logic circuits that can provide sufficient processing power depending on the configuration, purposes, and requirements of the CNC machine. In some embodiments, the processing circuitry can include more than one processor, with each processor being configured to perform different dedicated tasks, such as analyzing force data, coordinating CNC machine operations, and managing communication within the system.

In an embodiment, a Communication Network 104 facilitates smooth communication between the different components within the system 100. Its primary function is to ensure the seamless transmission of data between various modules, sensors, processors, and databases in real-time, enabling efficient coordination and integration of operations. Operating as a network infrastructure, the communication network 104 enables bidirectional data flow between components, allowing for the timely exchange of information crucial for the optimization of fabrication processes. It ensures that data collected from sensors, such as force sensors 102c, are efficiently relayed to processing units for analysis and interpretation.

For example, the Communication Network can include any network capable of carrying data, such as the Internet, Ethernet, plain old telephone service (POTS) line, public switched telephone network (PSTN), integrated services digital network (ISDN), digital subscriber line (DSL), coaxial cable, fiber optics, satellite, mobile, wireless (e.g., Wi-Fi, WiMAX), SS7 signaling network, fixed line, local area network, wide area network, and others, including any combination of these.

In an embodiment, server 106 is likely integrated as part of a central control unit or server infrastructure of system 100. The server 106 is adapted to execute more intricate computations and perform advanced data analysis tasks essential for optimizing fabrication processes. One key function of server 106 is to host specialized modules such as data collection module 106a, machine learning module 106b, an adaptive module 106c, and a feedback loop module 106d to enhance the system's intelligence and adaptability.

In an embodiment, the data collection module 106a gathers and structures data from various sources, including force sensors 102c and other relevant sources within the system 100. It retrieves raw data streams generated during the fabrication process, capturing crucial information about force exertion, material properties, and machine parameters. Once the data is gathered, the module structures it into a format suitable for analysis, making it more manageable and accessible for subsequent processing and analysis. The data collection module 106a module is responsible for timestamping and logging the data. This results in a time-series dataset that delineates the force profile for each part produced.

In a typical machine learning process, a model is initialized in a random state. The model is then tuned/trained using a set of training data. The training allows the model to make predictions, classify, and/or otherwise process subsequent data sets. Accordingly, larger sets of training data are generally preferred.

In an embodiment, the Machine Learning Module 106b serves as a critical component, responsible for analyzing the data collected from the Data Collection Module 106a, specifically focusing on force data collected during the fabrication process. The Machine Learning Module 106b is used to detect patterns and correlations between the force profiles exerted during fabrication and the quality outcomes of the fabricated parts. Additionally, Machine Learning Module 106b utilizes historical data to identify optimal force profiles, considering material properties and specific fabrication tasks. The ML model employs various forms, such as regression, time-series forecasting, or a complex neural network. These models generate force profiles for current parts, aiming for near-perfect results. Continuous learning occurs through periodic model retraining on new data for refined predictions and adaptation to evolving conditions.

In an embodiment, an adaptive control module 106c makes real-time adjustments to the CNC machine 102 based on the inputs from the machine learning analysis module 106b. These adjustments aim to replicate the optimal force profiles identified by the ML algorithm. An adaptive control module 106c controls variables such as the speed, acceleration, and positioning of the CNC components to achieve the desired force application.

In an embodiment, the Feedback Loop Module 106d operates on a closed-loop feedback mechanism. During the process wherein each part is fabricated, the ongoing force data is analyzed, and the machinery adjustments and corrective forming adjustments are made for the part during its fabrication process. This continuous loop allows for incremental improvements in fabrication quality and potentially automates the process of quality control.

Further, Memory 106e is responsible for storing both program instructions and data needed for the operation of the system 100. This includes software code for controlling the CNC machine 102 as well as historical force data collected during fabrication processes. Processor 106f processes the force sensor data collected during fabrication processes and is responsible for making real-time adjustments to the CNC machine 102 based on the analysis of force sensor data.

For example, Memory can be non-volatile and may include types such as erasable programmable read-only memory (EPROM), flash memory, and/or other electromagnetic media suitable for storing electronic data signals in volatile or non-volatile, non-transient form.

In an embodiment, a display unit 108 provides real-time visualizations of force sensor data, machine learning analysis results, and CNC machine parameters. Additionally, it allows operators to interact with the system 100 to view performance metrics and make adjustments as necessary to ensure optimal fabrication quality.

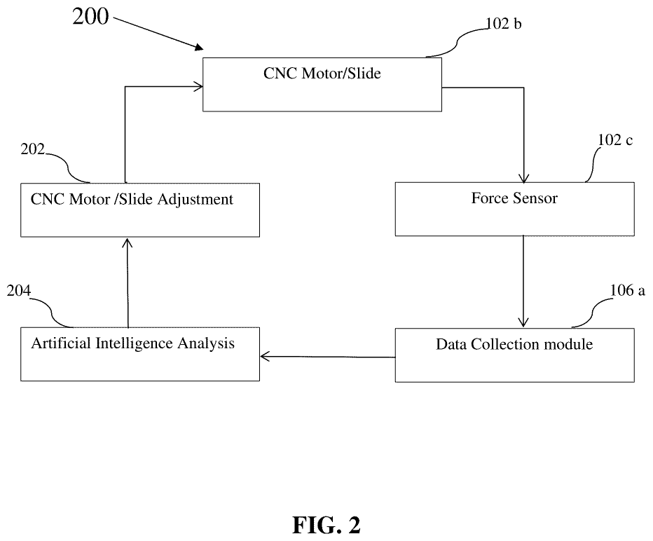

In an embodiment, FIG. 2 illustrates the sequential operation of the fabrication process using the components of FIG. 1. The CNC Motor/Slide (102b) initiates physical manipulations based on programmed instructions and forwards the data to the Force Sensor (102c) that measures the exerted force during fabrication. The measured force data is transmitted to the Data Collection module (106a). The Data Collection module (106a) organizes the collected force data into structured force data and then forwards it to the Artificial Intelligence Analysis module (204). The Artificial Intelligence Analysis module (204) scrutinizes the force data, identifying patterns and correlations. Based on the analysis, the CNC Motor/Slide Adjustment (202) module modifies the CNC machinery to replicate the desired force profile.

Further, Artificial Intelligence Analysis 204 employs machine learning (ML) models to analyze the collected force data from data collection module 106a. These models, trained on datasets containing force profiles labeled with quality outcomes (e.g., “perfect” or “defective”), learn to recognize the characteristics of force profiles that yield high-quality parts. The ML model analyzes new force data in real-time to predict the quality outcome of parts being produced, identifying the optimal force profile needed for perfect parts. Based on the ML analysis, the CNC Motor/Slide Adjustment 202 component, adjusts the CNC motor in real-time or the subsequent parts to replicate the ‘perfect’ force profile. This adjustment might include altering the speed, torque, or specific movement patterns of the CNC machine 102.

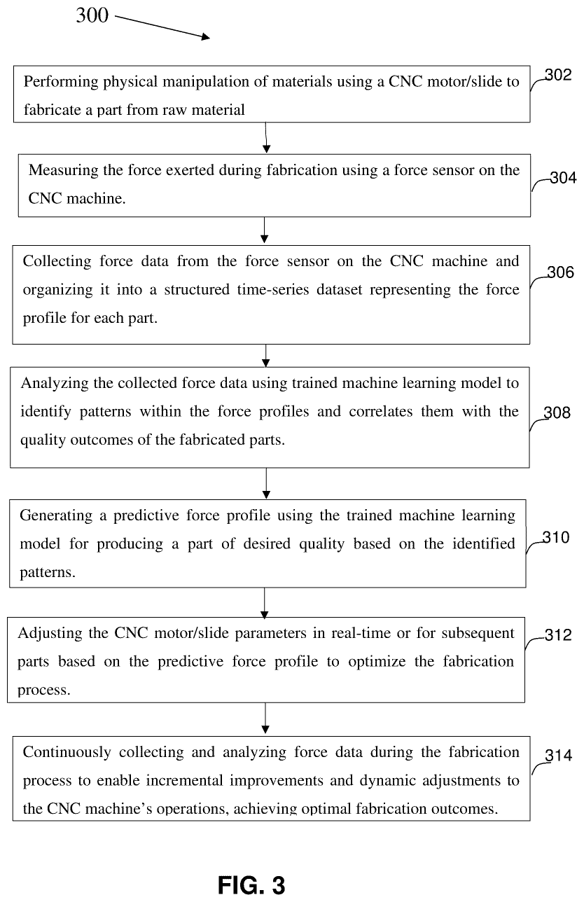

In an embodiment, the method depicted in FIG. 3 illustrates a method for optimizing fabrication processes in a computer-assisted machine tool 300. The process commences with step 302, involving the physical manipulation of workpiece 102a using a CNC motor/slide 102a to fabricate a part from raw material. Concurrently, step 304 involves the force exerted during the fabrication process, which is measured using a force sensor attached to the CNC machine 102. Following this, step 306 focuses on collecting force data from the force sensor on the CNC machine 102 and systematically organizing it into a structured time-series dataset, representing the force profile for each part being fabricated. Subsequently, in step 208, the collected force data undergoes analysis using a trained machine learning model. This analysis aims to identify patterns within the force profiles and correlate them with the quality outcomes of the fabricated parts. In step 310, a predictive force profile using the trained machine learning model is generated to produce a part of the desired quality. Then, in step 312, adjustments are made to the CNC motor/slide 102a parameters in real-time or for subsequent parts based on the predictive force profile to optimize the fabrication process. Throughout the fabrication process, force data is continuously collected and analyzed, as outlined in step 314, enabling iterative improvements and dynamic adjustments to the CNC machine 102 operations to achieve optimal fabrication outcomes.

The disclosed invention offers a revolutionary approach for optimizing fabrication processes using CNC machines by seamlessly integrating real-time force sensors with machine learning analysis. This integration allows for dynamic adjustments during the fabrication process based on direct force measurements, leading to higher precision and consistency in part quality. By employing a comprehensive ML-assisted framework, the system learns from historical data to identify optimal force profiles, enabling real-time adjustments to parameters like speed and torque to ensure each part meets desired specifications with minimal defects. The structured time-series dataset and closed-loop feedback mechanism facilitate continuous learning and process improvements, while potential automation of quality control processes enhances production efficiency and consistency. These inventive effects collectively revolutionize CNC machining, delivering improved quality, efficiency, and cost-effectiveness in part fabrication.

The advantages set forth above, and those made apparent from the foregoing description, are efficiently attained. Inasmuch as certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described and all statements of the scope of the invention that, as a matter of language, might be said to fall therebetween.

I/We claim:

1. A system for optimizing fabrication processes in a computer-assisted machine tool, the system comprising:
a computer numerical control (CNC) machine (102) having a CNC motor /slide (102a) configured to perform physical manipulation of a workpiece (102a) during a fabrication process and execute a range of movements based on programmed instructions to fabricate a part from a raw material;
a force sensor (102c) attached to the CNC motor/slide (102a) at a point of contact with the workpiece (102a) and configured to measure the force exerted during the fabrication process in real time;
a data collection module (106a) configured to collect and format the force data from the sensor into a time-series dataset, representing the force profile for each part produced;
a machine learning analysis module (106b) configured to analyze the collected force data to identify patterns correlating the force profile with the quality outcomes of the parts and capable of generating a predictive force profile for producing a part of desired quality, allowing for material-specific optimization;
an adaptive control module (106c) configured to adjust the CNC motor/slide parameters in real-time or for subsequent parts based on the predictive force profile generated by the machine learning analysis module (106b); and
a feedback loop module (106d) that continuously collects and analyzes force data during the fabrication process, enabling the system to make incremental improvements and dynamic adjustments to the CNC machine (102) operations to achieve optimal fabrication outcomes.

2. The system of claim 1, wherein the force sensor (102c) measures the forces in terms of torque or pressure in pounds per square inch (PSI).

3. The system of claim 1, wherein the machine learning model (106b) is selected from a group consisting of regression models, time-series forecasting models, and neural networks, and is trained to recognize patterns in the force data correlating with successful fabrication outcomes.

4. The system of claim 1, wherein the adaptive control module (106c) adjusts variables, including speed, torque, and specific movement patterns of the CNC machine (102), to replicate the predictive force profile.

5. The system of claim 1, wherein the feedback loop module (106d) operates on a closed-loop mechanism, continuously improving the precision of fabrication by learning from each part produced and making real-time adjustments to the CNC machine's operations.

6. The system of claim 1, further comprising safeguards to ensure that adjustments made by the adaptive control module fall within safe operational parameters for the CNC machine (102).

7. The system of claim 1, wherein the machine learning model (106b) is periodically retrained on new force data to refine its predictions and improve fabrication outcomes continuously.

8. The system of claim 1, wherein the CNC machinery performs fabrication tasks including cutting, bending, and forming on various metals such as Carbon Steel and Stainless Steel, which require precise force application.

9. The system of claim 1, wherein the data collection module (106a) is configured to timestamp and log the force data, ensuring a comprehensive dataset for each fabricated part.

10. The system of claim 1, wherein the adaptive control module (106c) implements corrective measures within less than 40 milliseconds during the fabrication process to produce parts that meet predefined quality specifications.

11. The system of claim 1, wherein the force sensors (102c) capture data indicative of dynamic forces involved during fabrication tasks, such as pressure, stress, strain, or torque, thereby enabling the detection of subtle variations affecting the quality of the output.

12. A method for optimizing fabrication processes in a computer-assisted machine tool, the method comprising:
performing physical manipulation of a workpiece (102a) using a CNC motor/slide (102a) configured for linear, rotary, or combined movements to fabricate a part from raw material;
measuring, in real-time, the force exerted during the fabrication tasks using a force sensor (102c) attached to the CNC machine (102) at the point of contact with the workpiece (102a);
collecting and formatting the force data from the force sensor (102c) into a time-series dataset representing the force profile for each part produced;
analyzing the collected force data using a trained machine learning model (106b) to identify patterns correlating the force profile with quality outcomes of the fabricated parts;
generating a predictive force profile using the trained machine learning model (106b) for producing a part of the desired quality based on the identified patterns;
adjusting the CNC motor/slide (102a) parameters in real-time or for subsequent parts based on the predictive force profile to optimize the fabrication process; and
continuously collecting and analyzing force data during the fabrication process to enable incremental improvements and dynamic adjustments to the CNC machine (102) operations, achieving optimal fabrication outcomes.
